(19) United States
(12) Patent Application Publication
(10) Pub. No.: US 2012/0152055 A1
(43) Pub. Date: Jun. 21, 2012

(54) STEERING WHEEL FOR VEHICLES WITH ERGONOMIC HANDLES

(76) Inventor: Juan Humberto Lechuga Priego, Guadalupe (MX)

(21) Appl. No.: 13/392,703

(22) PCT Filed: Dec. 21, 2009
(86) PCT No.: PCT/MX2009/000141

§ 371 Date: Feb. 27, 2012

(51) Int. Cl. B62D 1/04

(52) U.S. Cl. 74/557

(57) ABSTRACT

An ergonomic handle device for steering wheels of vehicles that includes a handle that can be grasped by the user's hand to turn the steering wheel of the vehicle and where the device enables the ergonomic handle to be moved around three predefined axes “X”, “Y” and “Z”.

### BACKGROUND OF THE INVENTION

A. Field of the Invention

The present invention relates to devices for holding and manipulating vehicle steering wheels, and more particularly to a vehicle steering wheel having one or more holding elements which have three degrees of freedom of movement, allowing the driver's hand to move freely on the three dimensional axes allowing him/her to drive the vehicle without ceasing to hold the handle.

B. Description of Related Art

During driving of a vehicle using a steering wheel, it is necessary that at a given moment the driver ceases to hold the wheel with both hands during certain operations such as changes in driving direction in which the wheel of the vehicle must be rotated over 360°.

This type of driving operations require the driver to have some expertise, experience and coordination of movements, and are virtually impossible to perform for people having some kind of problem in their arms, wrists, hands or lack of one or more limbs.

For example, referring to an automobile, operations such as U-turns and parks, often require that the wheel thereof is rotated about its own axis even more than three consecutive times depending on the characteristic rotation radius of the vehicle's steering system. In order to rotate the wheel three times about its own axis it is necessary to release and hold the steering wheel with both hands alternatively at least twice, operation that in emergency situations has to be performed quickly and accurately, which leads to errors and therefore loss of control of the vehicle if the driver does not have the necessary experience and expertise or has a disabled upper limb.

Considering these problems, several devices have been developed which function as handles that are incorporated into the steering wheel ring.

A device as mentioned above is disclosed in U.S. Pat. No. 5,289,736, which discloses an apparatus for rotating a steering wheel for handicapped people, which includes a rotatable handle which is attached to the steering wheel rim by means of a clamp, which can be removed if desired.

Another device is disclosed in U.S. Pat. No. 6,151,987, which claims a handle for steering wheels comprising a handle-shaped grip connected to the wheel with a special holding device that includes at least one clamp and means for releasably and rotatably holding said handle. The handle can be rotated over its own axis.

While the abovementioned devices provide the user the possibility to drive the vehicle without releasing the holding means that said devices provide, the only rotation axis of said holding means prevents the user's hand to move freely together with said holding means, whereby in abrupt maneuvers, the holding means, by not having various degrees of movement cannot move together with the user's hand, with the possibility that the user's hand lose momentary contact on the holding means and releases them, thus causing loss of vehicle control. Additionally, these devices mentioned above are not designed under the principles of ergonomics, anthropometry and anatomy, preventing the holding means to adapt to the body limbs, thus restricting the natural, comfortable and safe movements, and forcing, hurting and damaging the joints and upper limb muscles.

In view of the problems and needs above, the applicant developed a vehicle steering wheel which has three holding elements each having two degrees of freedom of movement, allowing the driver's hand to move freely on the three dimensional axes enabling him/her to drive the vehicle without releasing the handle.

Each ergonomic handle incorporated into the flywheel developed by the applicant can move in a controlled manner about the axes X, Y and Z as well as rotate about its own axis, giving it said two degrees of freedom of movement in each of the three dimensional axis (X, Y, Z).

The movements during use, fully guarantee the advantages of ergonomics as it adapts the handles to the body limbs in shape, angle and movements; it also allows the user's hand to move with natural, circular, simultaneous, opposite and symmetrical movements that match with our joints and natural shape of the body, without causing discomfort or awkward positions that cause fatigue and ultimately hurt the joints, muscles or limbs. In a specific embodiment of the invention, the parts that are in direct contact with the user can have almost the same shape as his/her body, to conform to the average contour of the hands, or to that of a specific user in order to customize the device.

### SUMMARY OF THE INVENTION

It is therefore a primary object of the present invention to provide a vehicle wheel which has one or more holding elements each comprising an ergonomic handle with three degrees of freedom of movement, allowing the driver's hand to move freely on the three dimensional axes allowing him/her to drive the vehicle without releasing the holding element, being of great importance to ensure maximum safety while driving the same.

Other primary object of the present invention is to provide a vehicle wheel of the nature described above in which each handle can be moved in a controlled manner about an axis X, Y and Z as well as rotate about its own axis, giving it said two degrees of freedom of movement in each of the three dimensional axes (X, Y, Z).

A further object of the present invention is to provide a vehicle wheel of the nature described above in which each handle allows the user's hand to move with circular, opposite, simultaneous and symmetrical movements matching our joints and natural shape of the body, without causing discomfort or awkward positions that cause fatigue or ultimately hurt the joints, muscles or limbs.

Another object of the present invention is to provide a vehicle wheel of the nature described above, wherein each handle allows to drive the vehicle without ceasing to hold the vehicle's wheel even in complicated and/or abrupt maneuvers.

An additional object of the present invention is to provide a vehicle wheel of the above described nature which allows to drive the vehicle by people with certain limitation in their arms, hands or wrists, or lacking an upper limb.

Still another main object of the present invention is to provide a vehicle wheel of the nature described above in which each handle allows the driver's hand to be always in contact with the holding element (handle) even in fast and abrupt maneuvers.

These and other objects and advantages of the present invention will become apparent to those persons having ordinary skill in the art from the following detailed description of the invention.

### BRIEF DESCRIPTION OF THE DRAWINGS

FIG. 1 is a perspective view of a vehicle steering wheel including two ergonomic handle devices according to a first embodiment of the present invention.

FIG. 2 is a front view of a vehicle steering wheel including two ergonomic handle devices according to a first embodiment of the present invention.

FIG. 3 is a perspective view of a partial cross section of the ergonomic handle device according to the present invention.

FIG. 4 is a perspective view of a total cross section of the ergonomic handle device according to the present invention.

FIG. 5 is a perspective view of a vehicle steering wheel including an ergonomic handle device according to a second embodiment of the present invention.

FIG. 6 is a top view of a vehicle steering wheel including an ergonomic handle device according to a second embodiment of the present invention.

FIG. 7 is a rear view of the ergonomic handle device according to a second embodiment of the present invention.

### DETAILED DESCRIPTION OF THE INVENTION

The invention will now be described according to a preferred embodiment thereof with reference to a common design vehicle steering wheel and the arrangement of axes X, Y and Z shown in the accompanying drawings, in which the same numbers and signs refer to the same elements described.

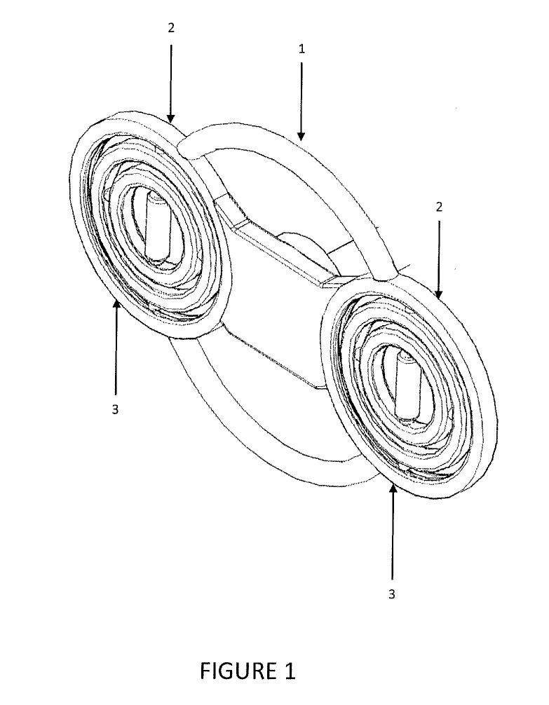

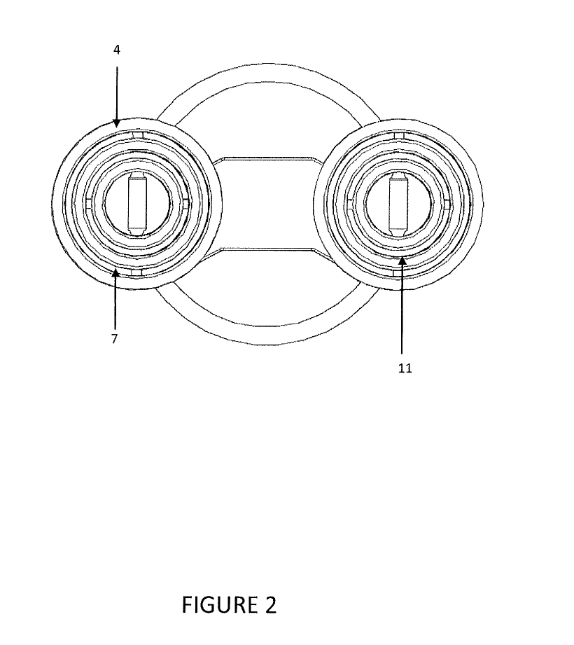

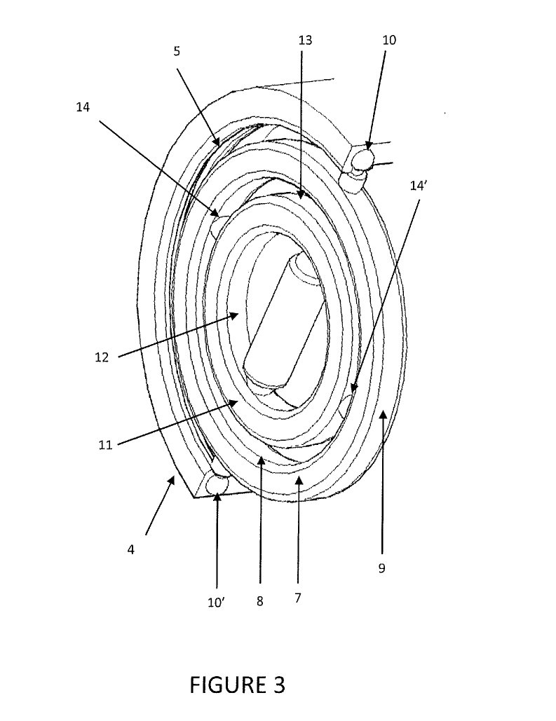

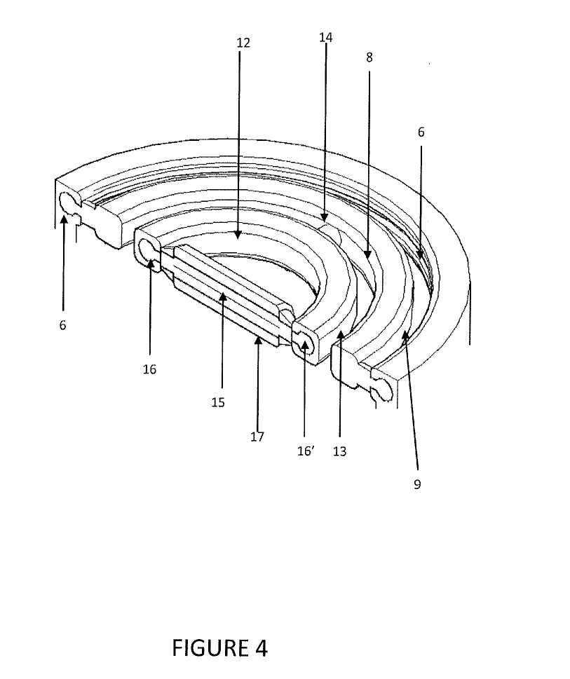

Referring to a first embodiment of the invention shown in FIGS. 1, 2, 3 and 4, the vehicle steering wheel with ergonomic handles 1 includes first and second ergonomic handle devices 2, 2′, wherein the first device is positioned oppositely to the second handle device and each comprising:

a circular opening 3 formed in the body of the wheel in a position such that the center of each circular aperture is located approximately at a distance from the center of the steering wheel 1 corresponding to half the radius of the wheel 1, leaving a portion outside the very circumference of the steering wheel, wherein the circular aperture diameter is greater than the average width of the human hand;

a fixed ring 4 made of a metal material fitted to said circular opening 3, wherein said fixed ring has a square shaped cross section and an inner annular portion 5 and wherein the inner annular portion 5 includes a circular channel 6 with a semicircular shaped cross-section;

a first movable ring 7 concentrically located with respect to the fixed ring 4, said first movable ring 7 having an inner annular portion 8 and an outer annular portion 9, and including first and second bead-shaped slidable connecting members 10, 10′ attached to the outer annular portion 9 in opposite positions to each other, wherein: said first movable ring 7 has a diameter smaller than the fixed ring 4, and wherein each slidable connecting member 10, 10′ is housed and slidably retained within the circular channel 6 having a circular cross-section, such that said first movable ring 7 can move around the axis “Z” sliding through the circular channel 6 by means of the slidable connecting means 10, 10′;

one second movable ring 11 concentrically located relative to the first movable ring 7, said second movable ring 11 having an inner annular portion 12 and an outer annular portion 13, and including first and second rotary connecting members 14, 14′ housed in receptacles located in the outer annular portion on opposite sides from each other, wherein: said second movable ring 11 has a smaller diameter than the first movable ring 7, wherein said first and second rotary connecting means 14, 14′ comprise a bushing and wherein each rotary connecting member 14, 14′ is rotatably attached to the inner annular portion 8 of the first movable ring 7, such that said second movable ring 11 is rotatable about the axis “Y” with respect to the first movable ring 7;

handle means for the user's hand, comprising an elongated rod 15 of circular cross-section, with a length slightly smaller than the diameter of the second movable ring 11, having first and second ends, wherein the first and second ends each include a rotary connecting member 16, 16′ housed in a receptacle located in the inner annular portion 12 of the second movable ring 11, each comprising a bushing and wherein each rotary connecting member 16, 16′ is rotatably attached to the inner annular portion 12 of the second movable ring 11, such that said elongated rod can rotate about its own axis;

a cover 17 made of plastic material surrounding said elongated rod 15, including striations (not shown) having a shape that conforms to the fingers of the user's hand when grasping the elongated rod 15 surrounded by said plastic cover, wherein said cover 17 may additionally be made of any material soft to the touch.

Thanks to the freedom of movement axes disclosed, the handle means comprising the elongated rod 17, can rotate:

around its own axis, due to the rotating connecting means 16, 16′ of the handle means;

about axis “Y” due to the rotating connecting means 14, 14′ of the second movable ring 11;

about axis “Z” due to the slidable connecting means 10, 10′ of the first movable ring 4.

Since the handle means can move around the three axes and “X”, “Y” and “Z” the user's hand is comfortably positioned within the circular opening area of the fixed ring 4, allowing it to rotate the vehicle wheel 1 without releasing the handle means and without the risk that the fingers can lose contact therewith in that the handle means rotate according to the movements of the driver's hand.

In other embodiments of the invention, the center of each circular opening can be located at a position between ½ R and R (including) where R is the radius of the wheel.

While it was disclosed that the first movable ring 4 is attached to the circular channel 6 by means of a first and a second bead-shaped slidable connecting members 10, 10′, it can also be attached to said channel by any attachment system that can slide through said channel 6.

Furthermore, while the drawings show that the steering wheel comprises two ergonomic handle devices, it is possible to use only one for driving the vehicle and although a common circular wheel design is shown, the wheel may have any design, including oval-shaped flywheels that some sports cars include, also, the assembly means may comprise a quadrangular opening for example, instead of a circular shaped opening.

In said first embodiment, it is necessary that the vehicle's steering wheel has one or more circular openings formed in the very body of the wheel in order to accommodate and fix the fixed ring 4, and the assembly of the first and second movable rings 7, 11 and handle means.

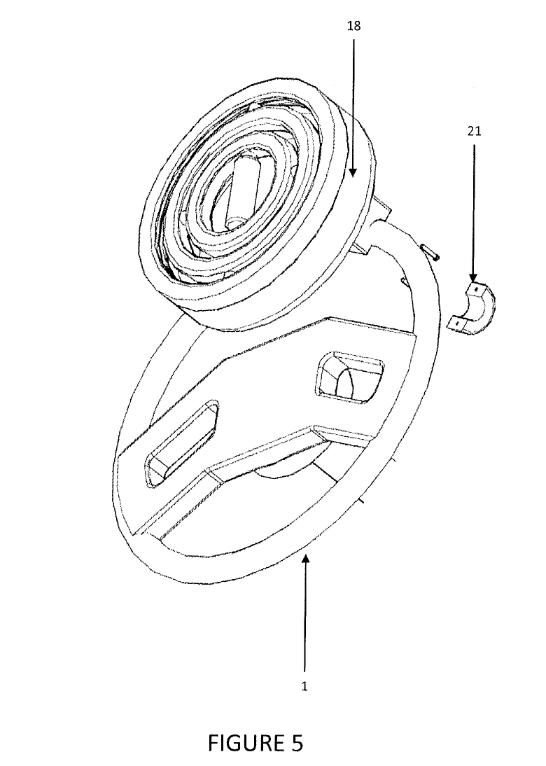

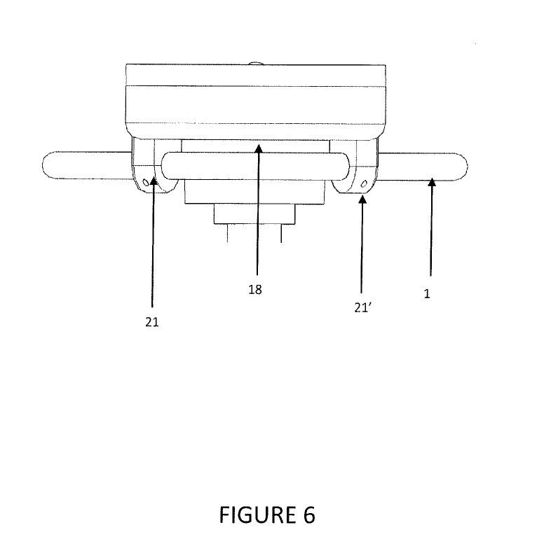

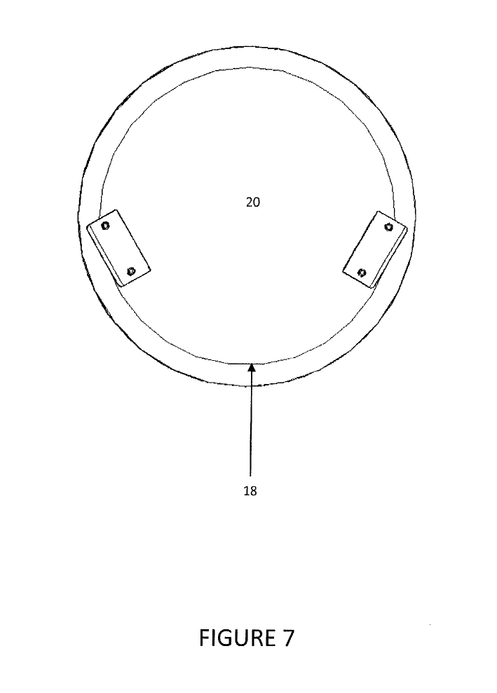

However in order to adapt the ergonomic handle device to a wide variety of existing wheel models, in a second embodiment of the present invention shown in FIGS. 5, 6 and 7, the fixed ring 4 is attached to assembly means which may comprise a hollow cylindrical container 18 having a circular front opening that includes an inner annular portion (not shown) and a rear wall 19 which includes an inner (not shown) and an external face 10, wherein the fixed ring 4 is attached to the inner periphery of the circular opening of said hollow cylindrical container 18 which includes a rear wall as shown in FIGS. 5, 6 and 7. In this embodiment, the first movable ring 4, the second movable ring 11 and handle means are assembled together in a similar manner as described in the first embodiment, and the hollow container 18 has such a depth that allows to grip the handle means without trapping the fingers against the rear wall 18 of the circular container. Thus, the assembly of the fixed ring 4, the movable rings 7, 11 and the handle means is attached to a separate circular container 18 which may be attached to a wide variety of existing steering wheels through the wheel attachment means attached the outer face of the rear wall of the circular container, which may for example comprise a pair of clamps 21, 21′ as shown in FIGS. 5, 6 and 7.

Ergonomics Studies

In order to determine the manner in which the human hand moves in relation to vehicle driving items (steering wheels), 105 experiments were carried out with random people including men, women, adolescents and adults. They were asked to sit down and a table was placed in front of them up to their elbows. They were asked to relax as much as possible their back, shoulders, elbows, and wrists. They were then asked to raise both forearms flexing their elbows to place their arms with palms down on the table in front of them. Before they placed their arms, they were asked to hold a pencil. Said position is the first to evaluate, holding a pencil with relaxed muscles, which is the natural position of elbow, forearm and wrist (position #1). Finally they were asked to naturally place their hands on the table without straining at all their muscles or joints, keeping the pencil held in each hand and letting them rest on the table (position #2).

Holding Angles

Horizontal Axis

Based on the manner in which the radius and ulna join at the wrist (radius-semilunar-scaphoid and ulna-pyramidal-pisiform), as well as the muscles and tendons in their natural state, it was concluded that the natural orientation of the hand (by placing it with the palm down) is at a slight inclination to the direction of the thumb (abduction). This inclination is increased by the time when the forearm is moved toward the center of the body of the person to hold the wheel (abduction), whose diameter is less than the distance between both shoulders. If a straight line is drawn from the elbow passing through the forearm, wrist, and reaching the fingertips, said line starting at the elbow would not end at the tip of the middle finger or heart, but at the tip of the ring finger. Based on said position we considered the degrees of freedom that the ergonomic handle of the present invention should have in order to achieve the gripping of the holding element in a horizontal axis, which is achieved through the combination of axes of freedom described above.

Vertical Axis

If the hands are placed with the palm facing the interior of the body, it can be concluded that a 90 degree angle between the horizontal axis and the palm of the hand does not form naturally, but that based on the structure of the forearm and wrist, an angle of about 45 degrees is formed (pronation). Similarly, based on said position, the degrees of freedom that the ergonomic handle of the present invention should have to achieve gripping of the holding element in a vertical axis were considered, which is achieved through the combination of axes of freedom described above.

Such ideal positions in the horizontal and vertical axes are part of a natural position of the hand grasping the handle means, which can rotate and adapt to said natural hand position thanks to the combination of axes of freedom described above.

Finally, it will be understood that the invention is not limited to the embodiments described above and that those skilled in the art will learn, through the teachings herein, to make changes in the components and configuration of the vehicle steering wheel with ergonomic handles of the present invention, which scope will be established only by the following claims.

1. An ergonomic handle device for vehicle steering wheels including a handle, wherein the handle can be taken by the hand of a user to turn the wheel of a vehicle and wherein the device allows the ergonomic handle to move around three predefined axes “X”, “Y” and “Z” comprising:
a fixed ring fixedly attached to assembly means, wherein said fixed ring has an inner and an outer annular portion and wherein the inner annular portion includes a circular channel;
a first movable ring concentrically located with respect to the fixed ring, said first movable ring having an inner annular portion and an outer annular portion, and including first and second slidable connecting members attached to the outer annular portion of the first movable ring in opposite positions to each other, wherein: said first movable ring has a diameter smaller than the fixed ring, and wherein each slidable connecting member is housed and slidably retained within the circular channel of the fixed ring, such that said first movable ring can move about an axis “Z” sliding over said circular channel through the slidable connecting means;
a second movable ring located concentrically with respect to the first movable ring, said second movable ring having an inner annular portion and an outer annular portion, and including first and second rotary connecting members attached to the outer annular portion on opposite sides of each another, wherein: said second movable ring has a diameter smaller than the first movable ring, and wherein each rotary connecting member rotatably attaches to the inner annular portion of the first movable ring, such that said second movable ring may rotate about an axis “Y” with respect to the first movable ring; and
handle means for the hand of a user, comprising an elongated rod with a length slightly less than the diameter of the second movable ring, having first and second ends, wherein the first and second ends each include a rotary connecting member, wherein each rotary connecting member is rotatably attached to the inner annular portion of the second movable ring, such that said elongated rod can rotate about its own axis.

2. An ergonomic handle device according to claim 1, wherein the assembly means comprise a hollow cylindrical container having a circular front opening that includes an inner annular portion, and a rear wall having an inner and an outer face, wherein the fixed ring is attached to said inner annular portion and wherein the outer face of the rear wall includes means for attaching the cylindrical container to the wheel of the vehicle.

3. An ergonomic handle device according to claim 1, wherein the fixed ring has a polygonal shaped cross-section.

4. An ergonomic handle device according to claim 1, wherein the fixed ring channel has a semicircular shaped cross-section.

5. An ergonomic handle device according to claim 1, wherein the first and second slidable connecting members of the first movable ring have the shape of a sphere and are slidably attached to the fixed ring channel which has a semi-circular shaped cross-section.

6. An ergonomic handle device according to claim 1, wherein the first and second rotary connection means of the second movable ring comprise a bushing.

7. An ergonomic handle device according to claim 1, wherein each of the rotary connection members of the handle means comprises a bushing.

8. An ergonomic handle device according to claim 1, wherein the handle means include a cover made of a soft-touch material surrounding the elongated rod, including striations having a shape that conforms to the fingers of the user's hand when grasping the elongated rod surrounded by said cover.

9. An ergonomic steering wheel for vehicles including at least one ergonomic handle device which includes a handle that can be held by the hand of a user to turn the wheel of a vehicle and wherein the device allows the ergonomic handle to move around three predefined axes “X”, “Y” and “Z” wherein the ergonomic steering wheel comprises:
at least one circular opening formed in the body of the wheel, said circular opening having an internal annular portion;
a fixed ring fixedly joined to the inner annular portion of said at least one circular opening, wherein said fixed ring has an inner and an outer annular portion and wherein the inner annular portion includes a circular channel;
a first movable ring concentrically located with respect to the fixed ring, said first movable ring having an inner annular portion and an outer annular portion, and including first and second slidable connecting members attached to the outer annular portion of the first movable ring in opposite positions to each other, wherein: said first movable ring has a diameter smaller than the fixed ring, and wherein each slidable connecting member is housed and slidably retained within the circular channel of the fixed ring, such that said first movable ring can move about an axis “Z” sliding over said circular channel through the slidable connecting means;
a second movable ring located concentrically with respect to the first movable ring, said second movable ring having an inner annular portion and an outer annular portion, and including first and second rotary connecting members attached to the outer annular portion on opposite sides of each another, wherein: said second movable ring has a diameter smaller than the first movable ring, and wherein each rotary connecting member rotatably attaches to the inner annular portion of the first movable ring, such that said second movable ring may rotate about an axis “Y” with respect to the first movable ring; and
handle means for the hand of a user, comprising an elongated rod with a length slightly less than the diameter of the second movable ring, having first and second ends, wherein the first and second ends each include a rotary connecting member, wherein each rotary connecting member is rotatably attached to the inner annular portion of the second movable ring, such that said elongated rod can rotate about its own axis, i.e., around the axis “X” with respect to the first movable ring.

10. An ergonomic steering wheel according to claim 9, wherein said at least one circular opening is located at a distance of between R and ½ R of the steering wheel's center, where R is the diameter of the wheel.

11. An ergonomic steering wheel according to claim 9, which has two circular openings, each of which is located at a distance of between R and ½ R of the steering wheel's center, where R is the diameter of the wheel and wherein a first handle is positioned opposite to a second handle.

12. An ergonomic steering wheel according to claim 9, wherein the fixed ring has a polygonal shaped cross-section.

13. An ergonomic steering wheel according to claim 9, wherein the fixed ring channel has a semicircular shaped cross-section.

14. An ergonomic steering wheel according to claim 9, wherein the first and second slidable connecting members of the first ring is sphere-shaped and are slidably attached to the fixed ring channel which has a semicircular cross-section.

15. An ergonomic steering wheel according to claim 9, wherein the first and second rotary connecting means of the second movable ring comprise a bushing.

16. An ergonomic steering wheel according to claim 9, wherein each of the rotary connecting members of the handle means comprises a bushing.

17. An ergonomic steering wheel according to claim 9, wherein the handle means include a cover made of a soft-touch material surrounding the elongated rod, including striations having a shape that conforms to the fingers of the user's hand when gripping the elongated rod surrounded by said cover.
